(19) United States
(12) Patent Application Publication
(10) Pub. No.: US 2026/0079355 A1
(43) Pub. Date: Mar. 19, 2026

(54) DISPLAY DEVICE USED BY BEING DISPOSED IN FRONT OF EYES OF USER

(71) Applicant: CANON KABUSHIKI KAISHA, Tokyo (JP)

(72) Inventor: HIROHITO KAI, Tokyo (JP)

(21) Appl. No.: 19/324,448

(22) Filed: Sep. 10, 2025

(30) Foreign Application Priority Data
Sep. 17, 2024 (JP) 2024-159820

(51) Int. Cl. G02B 27/01

(52) U.S. Cl. CPC G02B 27/0176; G02B 2027/0178

(57) ABSTRACT

A display device according to the present disclosure is a display device used by being disposed in front of eyes of a user, the display device including a body portion in which a display that displays an image on a rear-surface side of the display device is provided, and an end portion positioned on a right side or a left side of the body portion, wherein the end portion is connected to the body portion at an upper connection portion and a lower connection portion so as to form an opening between the body portion and the end portion, and a cable terminal is provided on a side of the end portion opposite to a side of the end portion closer to the body portion.

### BACKGROUND

### Field of the Technology

The present disclosure relates to a display device, such as a head-mounted display, which is used by being disposed in front of eyes of a user.

### Description of the Related Art

A display device that is used by being disposed in front of eyes of a user, such as a head-mounted display (HMD), has been proposed as a display device that provides a cross reality (XR) experience. XR includes virtual reality (VR), augmented reality (AR), mixed reality (MR), and the like.

There have been proposed an HMD (Japanese Patent Laid-Open No. 2019-532341) used by being worn on the head by using a band or the like, and an HMD (Japanese Patent Laid-Open No. 2020-527304) used by being installed on a stand. However, there is a need to omit a work of mounting (wearing, attaching) the HMD on the head and to easily perform the XR experience. In addition, in a case where the HMD is used by being installed on a fixed stand, a change in viewpoint is limited, but there is also a need to freely move the viewpoint. In order to meet these needs, an HMD used by attaching a handle has also been proposed.

Further, there is also a need for decreases in size and weight of the HMD. In order to meet this need, there have been proposed an HMD that does not have a battery and supplies power from an outside, and an HMD in which a size of a display unit (a display panel or a display optical system) is decreased.

However, in general, when the size of the display unit is decreased, a region that can be visually recognized through the HMD becomes small, and the user feels a sense of blockage due to the fact that an outside of the region cannot be visually recognized. In addition, in a case where the user using the HMD and another person face each other, the other person cannot see the eyes of the user and may feel difficulty in communication. There has also been proposed a configuration in which another display unit is provided on a front surface of the HMD and an image of the eye of the user of the HMD is displayed on the other display unit. However, the other display unit is provided to increase the size, weight, cost, and the like of the HMD.

### SUMMARY

The present disclosure provides a small display device in which a user can view an outside world (eyes of the user can be viewed from the outside world).

A display device according to the present disclosure is a display device used by being disposed in front of eyes of a user, the display device including a body portion in which a display that displays an image on a rear-surface side of the display device is provided, and an end portion positioned on a right side or a left side of the body portion, wherein the end portion is connected to the body portion at an upper connection portion and a lower connection portion so as to form an opening between the body portion and the end portion, and a cable terminal is provided on a side of the end portion opposite to a side of the end portion closer to the body portion.

Features of the present disclosure will become apparent from the following description of embodiments with reference to the attached drawings. The following description of embodiments is described by way of example.

### BRIEF DESCRIPTION OF THE DRAWINGS

FIG. 1A is an external perspective view of a display device.

FIG. 1B is a front view of the display device.

FIG. 1C is an external perspective view of the display device.

FIG. 2 is a sectional view of the display device.

FIG. 3A is an external perspective view of a display device.

FIG. 3B is an external perspective view of an end portion.

FIG. 3C is a sectional view of the display device.

### DESCRIPTION OF THE EMBODIMENTS

Hereinafter, an embodiment of the present disclosure will be described with reference to the accompanying drawings. Note that, the following embodiment does not limit the disclosure according to the claims. Although a plurality of features are described below, not all of the plurality of features are essential to the disclosure. The plurality of features may be voluntarily combined. Further, in the accompanying drawings, the same or similar components are denoted by the same reference numerals, and redundant description is omitted.

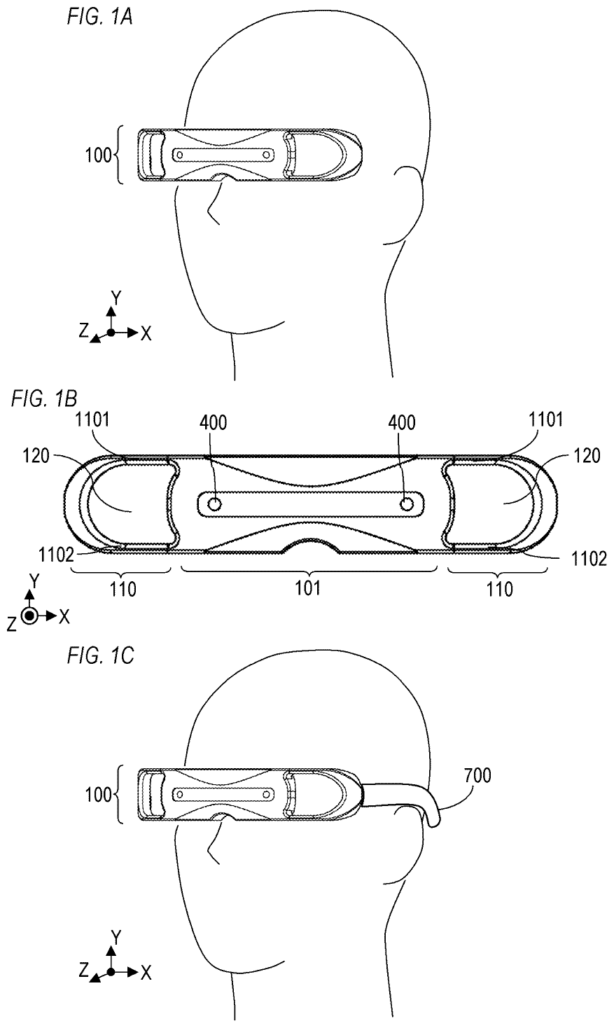

FIG. 1A is an external perspective view illustrating a scene in which a user disposes a display device 100 according to the present embodiment in front of eyes and uses the display device. In the present embodiment, the display device 100 is a head-mounted display (HMD), but the display device 100 is not limited to the HMD, and features of the present embodiment can be applied to various display devices used by being disposed in front of the eyes of the user to achieve the display device 100. A left-right direction of the user in the state of FIG. 1A in which the user disposes the display device 100 in front of the eyes is a left-right direction of the display device 100, and an up-down direction of the user is an up-down direction of the display device 100. A surface of the display device 100 facing the user is a rear surface of the display device 100. Then, a surface of the display device 100 opposite to the rear surface of the display device 100 is a front surface of the display device 100. In FIG. 1A, an X direction is a left-right direction, a Y direction is an up-down direction, and a Z direction is a front-rear direction (front surface-rear surface direction).

FIG. 1B is a front view of the display device 100. The display device 100 includes a body portion 101 and two end portions 110 positioned on a right side and a left side of the body portion 101. Note that, in the present embodiment, the display device 100 is an HMD for both eyes, but the display device 100 may be an HMD for one eye. In this case, the end portions 110 may be present only on one of the right side and the left side of the body portion 101.

The body portion 101 includes display units (display units 500 to be described later) that display an image on a rear-surface side of the display device 100. The image is displayed on the rear-surface side of the display device 100, and thus, it is possible to provide a cross reality (XR) experience to the user. XR includes virtual reality (VR), augmented reality (AR), mixed reality (MR), and the like. The body portion 101 also includes a camera 400 (imaging unit) that images a front-surface side of the display device 100. The number of cameras 400 is not particularly limited, but in the present embodiment, the body portion 101 includes two cameras 400 arranged in the left-right direction. An image captured by the camera 400 (an image based on the captured image) is used, for example, as a background image to be displayed for the XR experience.

The end portion 110 is, for example, a holding portion (hand carry portion) used by the user to hold the display device 100. The end portion 110 is provided, and thus, the user can hold the display device 100 without touching the body portion 101. As a result, dirt and scratches on the body portion 101 can be reduced. In a case where display device 100 includes a fan therein, it is possible to prevent the user from unintentionally closing inlet and outlet ports of the fan.

The end portion 110 is connected to the body portion 101 at an upper connection portion 1101 and a lower connection portion 1102 so as to form an opening 120 between the body portion 101 and the end portion 110. As a result, a field of view of the user can be secured. The user can also see an outside world through the opening 120 during the XR experience. The outside world is visible through the opening 120, and thus, the user can have the XR experience without a sense of blockage even though a region (an angle of view of the image to be displayed) visible through the display device 100 is small. In addition, since the eyes of the user can be viewed from the outside world through the opening 120, it is easy for the user and another person to communicate with each other.

As a method for holding the HMD, there is a method for connecting an upper portion (one point) of the HMD to a lower center portion of an inverted U-shaped handle and holding the handle with both hands. In this method, since there is one connection point, when the connection point is not large, sufficient strength as the strength of the connection point cannot be obtained, and it is difficult to decrease a size of the HMD. In the present embodiment, since there are two connection points of the upper connection portion 1101 and the lower connection portion 1102, it is easy to obtain sufficient strength as the strength of the connection point even though the connection point is small, and the size of the display device 100 can be decreased.

Note that, the opening 120 may be closed with a light transmitting member. The opening 120 may be closed on the front-surface side of the display device 100, the opening 120 may be closed on the rear-surface side of the display device 100, or the opening 120 may be closed inside the opening 120. The entire opening 120 may be closed, or a part of the opening 120 may be closed. The light transmitting member may be decorated by coloring, drawing a pattern, surface treatment, or the like as long as the visual recognition of the outside world is not hindered. The opening 120 may be closed with a light transmitting member in a pattern that creates an aesthetic feeling. As a result, it is possible to give a degree of freedom in design and to improve the strength of the end portion 110 without hindering the visual recognition of the outside world.

In addition, from the viewpoint of decrease in size, it is preferable that a length of the display device 100 including the body portions 101 and the end portion 110 in the left-right direction is short. In the present embodiment, a glasses accessory (a glasses accessory 700 to be described later) which is a helical member of glasses is connected (attached) to the display device 100, and the display device 100 can be worn on the head without holding the display device. In this case, when the user wears the glasses, the glasses and the glasses accessory interfere with each other, and deviation of the glasses, deviation of the display device 100, and discomfort of the user are likely to occur. From the viewpoint of suppressing the interference between the glasses and the glasses accessory, a length of the display device 100 in the left-right direction is preferably 120 mm or more, and more preferably 140 mm or more.

In addition, at least a part of a surface of the end portion 110 on the opening 120 side (for example, a surface of the upper connection portion 1101 and a surface of the lower connection portion 1102) may be an inclined surface along the field of view of the user. This inclined surface is, for example, an inclined surface that moves away from the body portion 101 at an average viewing angle of a human from the rear-surface side to the front-surface side of the display device 100. The field of view of the user extends conically from the pupil. At least a part of the surface of the end portion 110 on the opening 120 side is set as the inclined surface along the conical field of view (side surface of the cone), and thus, it is possible to reduce a portion of the end portion 110 that hinders the visual recognition of the outside world.

In addition, at least one of the upper connection portion 1101 and the lower connection portion 1102 may have a shape in which a thickness at a position close to the body portion 101 is larger than a thickness at a position far from the body portion 101. At least one of the upper connection portion 1101 and the lower connection portion 1102 is thick at the position close to the body portion 101, and thus, the strength of the connection between the body portion 101 and the end portion 110 can be improved.

FIG. 1C is an external perspective view illustrating a scene in which the user wears the display device 100 to which the glasses accessory 700 is connected on the head and uses the display device. As described above, the glasses accessory 700 is a wearing member (mounting member, attachment member) for wearing the display device 100 on the head (disposing in front of the eyes) without holding.

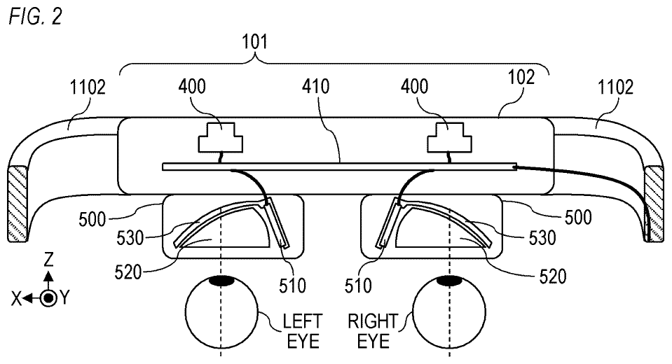

FIG. 2 is a sectional view of the display device 100 obtained by a horizontal surface (a surface perpendicular to the up-down direction). FIG. 2 also illustrates the eyes of the user using the display device 100.

The body portion 101 includes the display units 500. In the present embodiment, it is assumed that a left-eye display unit 500 and a right-eye display unit 500 are arranged in the left-right direction. The display unit 500 includes a display panel 510, a display prism 520, and a prism holder 530. The display panel 510 is a liquid crystal display (LCD), an organic light-emitting diode (OLED), or the like, and displays an image for the XR experience. The display prism 520 is, for example, a free-form-surface prism, and is a display optical system for projecting an image displayed on the display panel 510 to the eye of the user. The prism holder 530 is a holding member that holds the display panel 510 and the display prism 520. In the present embodiment, it is assumed that interpupillary distance (IPD) adjustment for adjusting an interval between the two display units 500 to match the IPD of the user can be performed. At the time of the IPD adjustment, the display panel 510, the display prism 520, and the prism holder 530 move integrally.

The camera 400 is an imaging unit that images a real space. As described above, an image captured by the camera 400 (an image based on the imaged image) is used, for example, as the background image to be displayed for the XR experience. The imaged captured may be used to detect a feature point such as a marker or an edge of an object and estimate a position and a posture of the display device 100, or may be used for space recognition.

A control board 410 estimates the position and posture of the display device 100, generates a CG image based on the estimated position and posture, and combines the background image and the CG image. A camera for acquiring the background image and a camera for estimating the position and posture of the display device 100 may be the same or different. As the camera for estimating the position and posture of the display device 100, a camera having a wide angle of view and a high shutter speed may be used, or a stereo camera having a long base length may be used. A gyro sensor for detecting changes in the position and posture of the display device 100 may be provided in the body portion 101. The gyro sensor is used, and thus, the detection (estimation) accuracy of the position and posture of the display device 100 can be improved.

An exterior 102 is an exterior member that holds each member described above.

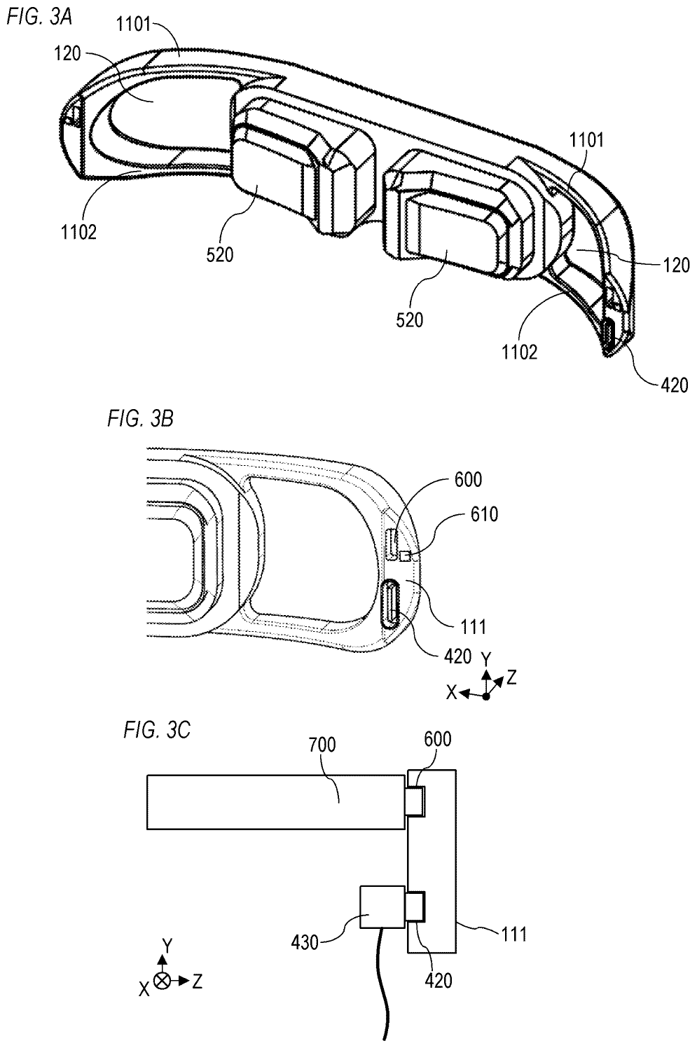

FIG. 3A is an external perspective view illustrating the rear-surface side of the display device 100.

A cable terminal 420 is provided on a side of the end portion 110 opposite to the body portion 101 side. A cable 430 such as a communication cable or a power supply cable is connected to the cable terminal 420. According to such a configuration (cable connection), it is possible to suppress the cable 430 from crossing the opening 120, and it is possible to suppress the visual recognition of the outside world from being hindered by the cable 430. The cable terminal 420 may be provided on both the left and right two end portions 110, but in the present embodiment, the cable terminal 420 is provided only on one of the two end portions 110.

In a case where the cable 430 is the communication cable, the control board 410 may communicate with an external device such as a personal computer, a smartphone, or a controller via the cable 430, and cause the external device to perform some processing. In a case where the cable 430 is the power supply cable, power may be supplied from an outside via the cable 430, and the power may be used for processing (operation) of at least a part of the display device 100. Accordingly, the decrease in size and power saving of the display device 100 can be realized. In addition, a size of the control board 410 can be decreased, and heat generation of the control board 410 can be suppressed.

FIG. 3B is an external perspective view of the end portion 110. A connection portion of the glasses accessory 700 is further provided on a side of the end portion 110 opposite to the body portion 101 side. The number of connection portions is not particularly limited, but in the present embodiment, a plurality of connection portions of different types (a recessed portion 600 and a sheet metal 610 in FIG. 3B) are provided as the connection portions.

The recessed portion 600 is used for positioning the glasses accessory 700. For example, a protrusion portion of the glasses accessory 700 is inserted into the recessed portion 600, and thus, the glasses accessory 700 can be attached to an appropriate position of the display device 100.

The sheet metal 610 is used to fix the glasses accessory 700. For example, a magnet provided on the glasses accessory 700 is brought into contact with the sheet metal 610, and thus, the glasses accessory 700 can be fixed to the display device 100 by a magnetic force. As a result, the glasses accessory 700 can be difficult to be detached from the display device 100. Note that, the method for fixing the glasses accessory 700 is not limited thereto, and the glasses accessory 700 may be fixed to the display device 100 by a claw structure, a lock mechanism, or the like.

FIG. 3C is a sectional view of the display device 100 obtained by a surface passing through the cable terminal 420 and the recessed portion 600. FIG. 3C also illustrates the glasses accessory 700 and the cable 430.

The recessed portion 600 (and the sheet metal 610) is provided on an upper side of the cable terminal 420. The cable 430 connected to the cable terminal 420 often extends downward according to gravity. The recessed portion 600 (and the sheet metal 610) is provided on the upper side of the cable terminal 420, and thus, interference between the glasses accessory 700 and the cable 430 can be suppressed. As illustrated in FIG. 3C, a cable bent in an L shape from the cable terminal 420 is used as the cable 430, and thus, the interference between the glasses accessory 700 and the cable 430 can be further suppressed.

A wiring that connects the cable terminal 420 and the body portion 101 (for example, the control board 410) passes through an inside of the end portion 110 and does not pass through the opening 120. Thus, it is possible to suppress the visual recognition of the outside world from being hindered by the wiring. Since the cable terminal 420 is provided below the recessed portion 600 (and the sheet metal 610), it is preferable that the wiring passes through an inside of the lower connection portion 1102. In doing so, the cable terminal 420 and the body portion 101 can be connected by an appropriate path (short path).

Note that, it is preferable that a depth direction of the recessed portion 600 and a depth direction of the cable terminal 420 are substantially parallel. In doing so, the cable 430 is disposed along the glasses accessory 700, and the interference therebetween can be easily suppressed.

Note that, although the embodiments of the present disclosure have been described in detail, the present disclosure is not limited by these specific embodiments. Various forms in the range without departing from the gist of the disclosure shall also be encompassed by the present disclosure. Further, the above-described embodiments merely illustrate embodiments of the present disclosure, and the embodiments can be combined as necessary.

According to the present disclosure, it is possible to provide a small display device in which the user can view the outside world (the eyes of the user can be viewed from the outside world).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159820, filed Sep. 17, 2024, which is hereby incorporated by reference herein in its entirety.

What is claimed is:

1. A display device used by being disposed in front of eyes of a user, the display device comprising:
a body portion in which a display that displays an image on a rear-surface side of the display device is provided; and
an end portion positioned on a right side or a left side of the body portion,
wherein the end portion is connected to the body portion at an upper connection portion and a lower connection portion so as to form an opening between the body portion and the end portion, and
a cable terminal is provided on a side of the end portion opposite to a side of the end portion closer to the body portion.

2. The display device according to claim 1,
wherein the display device includes a first end portion positioned on the right side of the body portion and a second end portion positioned on the left side of the body portion, and
the cable terminal is provided at one of the first end portion and the second end portion.

3. The display device according to claim 1, further comprising
a light transmitting member that closes the opening.

4. The display device according to claim 1, wherein a length of the display device in a left-right direction is 120 mm or more.

5. The display device according to claim 1, wherein a connection portion of an accessory is further provided on a side of the end portion opposite to a side of the end portion opposite closer to the body portion.

6. The display device according to claim 5, wherein the accessory is a mounting member for mounting the display device on a head.

7. The display device according to claim 5, wherein the display device includes a plurality of connection portions of different types.

8. The display device according to claim 5, wherein the connection portion is provided on an upper side of the cable terminal.

9. The display device according to claim 5,
wherein the connection portion includes a recessed portion, and
a depth direction of the recessed portion and a depth direction of the cable terminal are substantially parallel to each other.

10. The display device according to claim 1, further comprising
a wiring that passes through an inside of the end portion and connects the cable terminal and the body portion.

11. The display device according to claim 10, wherein the wiring passes through an inside of the lower connection portion.

12. The display device according to claim 1, wherein at least a part of a surface of the end portion on a side closer to the opening is an inclined surface along a field of view of a user.

13. The display device according to claim 1, wherein at least one of the upper connection portion and the lower connection portion has a shape in which a thickness at a position close to the body portion is larger than a thickness at a position far from the body portion.
